(19) United States
(12) Patent Application Publication
(10) Pub. No.: US 2006/0285575 A1
(43) Pub. Date: Dec. 21, 2006

(54) Thermal sensing apparatus and computer system incorporating the same

(75) Inventor: Jeong-gyu Park, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/434,105

(22) Filed: May 16, 2006

(30) Foreign Application Priority Data
Jun. 16, 2005 (KR) 2005-52083

(51) Int. Cl. G01K 1/14

(52) U.S. Cl. 374/141

(57) ABSTRACT

A thermal sensing apparatus is provided with a simple diode module for sensing a temperature of a plurality of points or positions within a computer system. Such a thermal sensing apparatus comprises: a plurality of heat sensing units provided at different points or positions for sensing heat generated from one or more sensing subjects; a plurality of switching units connected to the plurality of heat sensing units; and a signal generator which compares a predetermined standard voltage and an input signal, which is changed when at least one of the plurality of switching units turns on, based on a sensing result from the plurality of heat sensing units, and generates a predetermined thermal sensing signal according to a comparision result.

### CROSS-REFERENCE TO RELATED APPLICATIONS

This application claims all benefits accruing under 35 U.S.C. §119 from Korean Patent Application No. 2005-52083, filed on Jun. 16, 2005 in the Korean Intellectual Property Office, the disclosure of which is incorporated by reference herein.

### BACKGROUND OF THE INVENTION

1. Field of the Invention

The present invention relates to a thermal sensing apparatus, and more particularly, to a thermal sensing apparatus and a computer system incorporating the same for effectively sensing a temperature of a plurality of points within the computer system.

2. Related Art

Generally, a computer system includes a cooling fan to cool heat generated by consumption of power. Typically, such a consumption of power is not regular and becomes larger in proportion to a load. Therefore, if the cooling fan is regularly driven regardless of the consumption of power, over cooling can occur, and needless noise can be generated.

Therefore, most computer systems are provided with a thermal sensing apparatus for sensing a temperature variation of a circuit part (e.g., a central processing unit “CPU”) to determine the heat generation. Such a computer system includes a cooling controller for controlling the operation of the cooling fan, i.e., to turn on/off the cooling fan according to the temperature variation sensed from the thermal sensing apparatus.

A typical thermal sensing apparatus is provided with a thermistor in a circuit part to sense the heat generation. Usually, such a thermistor has a characteristic that a resistance value reduces according as a peripheral temperature (i.e., a temperature of the circuit part provided with the thermistor) increases.

For example, FIG. 1 shows a typical thermal sensing apparatus for use in a computer system. As shown in FIG. 1, the thermal sensing apparatus includes resistors R1 and R2 connected in series between a voltage terminal Vcc and a ground terminal; a resistor RT and a thermistor RTH connected in series between a voltage terminal Vcc and a ground terminal in parallel with the resistors R1 and R2; a capacitor C arranged in parallel with the thermistor RTH; and a comparator 5 arranged to receive the voltage value applied to the thermistor RTH as an input signal and compare a predetermined standard voltage and the voltage of the input signal to output a thermal sensing signal. That is, the comparator 5 receives the voltage value dropped by a resistance R2 as the standard voltage, and the voltage value dropped by the thermistor RTH as the input signal. At this time, the comparator 5 outputs the thermal sensing signal to a cooling fan controller (not shown) when the voltage of the input signal is smaller than the standard voltage. Therefore, the cooling fan controller (not shown) controls the cooling fan according to the thermal sensing signal from the thermal sensing apparatus to cool the heat of the circuit part provided with the thermistor RTH.

Meanwhile, recent computer systems have become increasingly high-speed. As a result, a central processing unit (CPU) and/or peripheral circuit parts consume a great deal of power. Therefore, the thermal sensing apparatus is required to have a structure of sensing a temperature of a plurality of circuit parts, that is, a plurality of points within a computer system. However, it has been difficult for the conventional thermal sensing apparatus as shown in FIG. 1 to employ a structure for sensing the temperature of the plurality of points.

Turning now to FIG. 2, a conventional thermal sensing apparatus for sensing the temperature of a plurality of points is illustrated. As shown in FIG. 2, such a thermal sensing apparatus comprises a plurality of thermal sensor ICs, for example, a first thermal sensor IC 1, a second thermal sensor IC 2, and a third thermal sensor IC 3 respectively provided in a plurality of circuit parts for sensing the heat generation. The first thermal sensor IC 1, the second thermal sensor IC 2, and the third thermal sensor IC 3 respectively generate sensing signals according to a temperature variation of each circuit part (i.e., a peripheral temperature), and transmit the same to a master sensor IC 7, via a respective system management bus (SMBUS). The master sensor IC 7 then collects each of the sensing signals from the first thermal sensor IC 1, the second thermal sensor IC 2, and the third thermal sensor IC 3, and generate a thermal sensing signal for output to a cooling fan controller (not shown). The cooling fan controller (not shown) controls the cooling fan according to the thermal sensing signal input from the thermal sensing apparatus, and cools the heat of each circuit part accordingly.

However, the thermal sensing apparatus as described in connection with FIG. 2, for sensing the temperature of the plurality of points must use expensive thermal sensor ICs 1, 2, 3, which in turn raise the cost of production significantly. Moreover, the thermal sensor ICs 1, 2, 3, are provided in the plurality of circuit parts for sensing the heat generation. As a result, a lot of mounting space on lay-out is required. Furthermore, the communication arrangement between the thermal sensor ICs 1, 2, 3, and the master sensor IC 7 requires that a realized circuit be complicated. As a result, the reliability is deteriorated by communication error.

### SUMMARY OF THE INVENTION

Various aspects and example embodiments of the present invention advantageously provide a thermal sensing apparatus and a computer system incorporating the same for effectively sensing a temperature of a plurality of points within such a computer system using a simple diode module.

Additional aspects and/or advantages of the invention will be set forth in part in the description which follows and, in part, will be obvious from the description, or may be learned by practice of the invention.

In accordance with an aspect of the present invention, a thermal sensing apparatus for sensing a temperature of a plurality of points, comprises a plurality of heat sensing units provided to sense a temperature of a plurality of circuit parts, each of which is arranged at a position where one or more circuit parts are located; a plurality of switching units connected to the plurality of heat sensing units; and a signal generator which compares a predetermined standard voltage and an input signal, which is changed when at least one of the plurality of switching units turns on, based on a sensing result from the plurality of heat sensing units, and generates a thermal sensing signal according to a comparison result.

According to an aspect of the present invention, the plurality of heat sensing units comprise a thermistor used as a semiconductor circuit element of which an electric resistance value reduces when a temperature of the corresponding one or more circuit part rises. The plurality of switching units comprise a diode connected according to a variation of the electric resistance value of the plurality of thermistors.

According to an aspect of the present invention, the plurality of thermistors are arranged in parallel with each other, and are provided at positions where the circuit parts are located.

According to an aspect of the present invention, the thermal sensing apparatus further comprises ground lines passing through the plurality of thermistors and predetermined ground resistors connected to rear ends of the plurality of thermistors; and connection lines which are branched between the rear ends of the plurality of thermistors and the ground resistors to allow connection signals output from the plurality of thermistors to pass through the plurality of diodes and to be supplied to the signal generator, wherein the plurality of diodes are disposed in parallel with the ground resistors.

According to an aspect of the present invention, each of the plurality of diodes is provided in the connection line and has an anode terminal connected to the rear end of each of the plurality of thermistors, and a cathode terminal connected to the signal generator.

According to an aspect of the present invention, the signal generator corresponds to a comparator having a non-inverting terminal (+) to which the connection signals supplied from the plurality of diodes provided in the connection lines are input as an input signal, and an inverting terminal (−) to which the predetermined standard voltage is input, to compare the voltage of the input signal with the standard voltage and generate the thermal sensing signal according to the comparison result.

According to an aspect of the present invention, the comparator generates a low signal when the standard voltage is larger than the voltage of the input signal, and generates a high signal when the voltage of the input signal is larger than the standard voltage, in accordance with the comparison result.

According to an aspect of the present invention, the thermal sensing apparatus further comprises first lines passing through first resistors connected to front ends of the plurality of thermistors and the plurality of thermistors to be grounded; and second lines which pass through the plurality of diodes and are connected to the plurality of thermistors through union points between the first resistors and the front ends of the plurality of thermistors, wherein the plurality of diodes are disposed in parallel with the first resistors.

According to an aspect of the present invention, the plurality of diodes are provided in the second lines and have anode terminals receiving the connection signals from the power supply source, and cathode terminals connected to the union points and supplying the connection signals to the plurality of thermistors.

According to an aspect of the present invention, the signal generator corresponds to a comparator having an inverting terminal (−) to which the power input to the anode terminal of the diode and dropped according to the connection signals is input as an input signal, and a non-inverting terminal (+) to which the predetermined standard voltage is input, to compare the voltage of the input signal with the standard voltage and generate the thermal sensing signal according to the comparison result.

According to an aspect of the present invention, the comparator generates a low signal when the voltage of the input signal is larger than the standard voltage, and generates a high signal when the standard voltage is larger than the voltage of the input signal, in result of the comparison.

In accordance with another aspect of the present invention, a computer system is provided with a thermal sensing circuit arranged to sense a temperature of a plurality of circuit parts and to generate a thermal sensing signal; a cooling fan for cooling one or more circuit parts; and a controller for controlling the operation of a cooling fan, based on the thermal sensing signal generated from the thermal sensing circuit, wherein the thermal sensing circuit comprises a plurality of heat sensing units each of which is arranged at a position where one or more circuit parts are located; a plurality of switching units connected to the plurality of heat sensing units; and a signal generator which compares a predetermined voltage and an input signal, which is changed when at least one of the plurality of switching units turns on, based on a sensing result from the plurality of heat sensing units, and which generates the thermal sensing signal according to a comparison result.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a circuit diagram of a typical thermal sensing apparatus for sensing a temperature of a single point in a computer system;

FIG. 2 is a circuit diagram of a typical thermal sensing apparatus for sensing a temperature of a plurality of points in a computer system;

FIG. 3 is a block diagram of an example computer system incorporating a thermal sensing apparatus according to an embodiment of the present invention;

FIG. 4 illustrates example thermal sensing points or positions of a plurality of thermal sensing units of a computer system according to an embodiment of the present invention;

FIG. 5 is a circuit diagram of an example thermal sensing apparatus according to a first embodiment of the present invention;

FIG. 6A is a circuit diagram of an example thermal sensing apparatus according to a second embodiment of the present invention; and

FIG. 6B and FIG. 6C illustrate an equivalent circuit according to a diode connection of the circuit diagram of the thermal sensing apparatus shown in FIG. 6A.

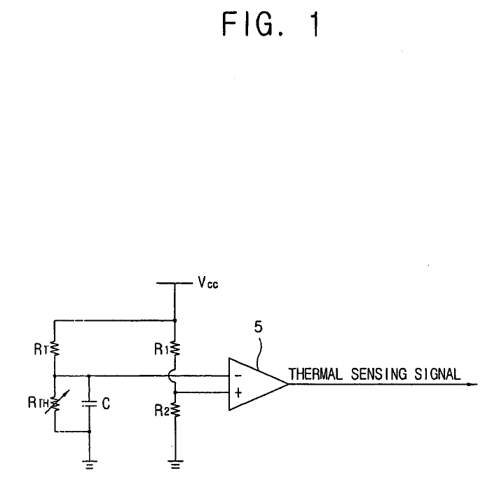

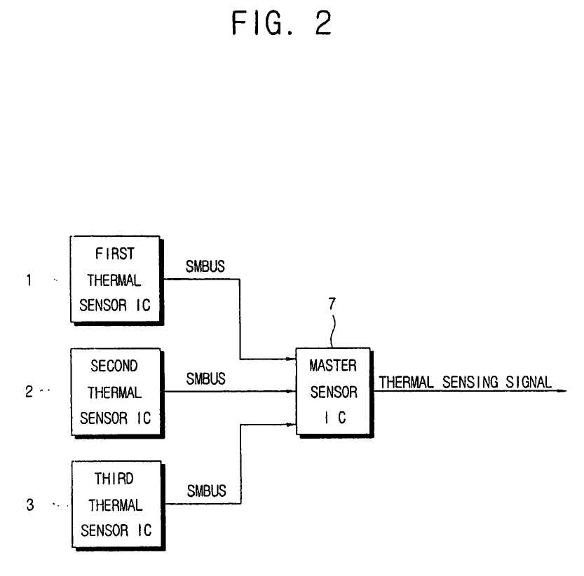

### DETAILED DESCRIPTION OF THE PREFERRED EMBODIMENT

Reference will now be made in detail to the embodiments of the present invention, examples of which are illustrated in the accompanying drawings, wherein like reference numerals refer to like elements throughout. The embodiments are described below in order to explain the present invention by referring to the figures.

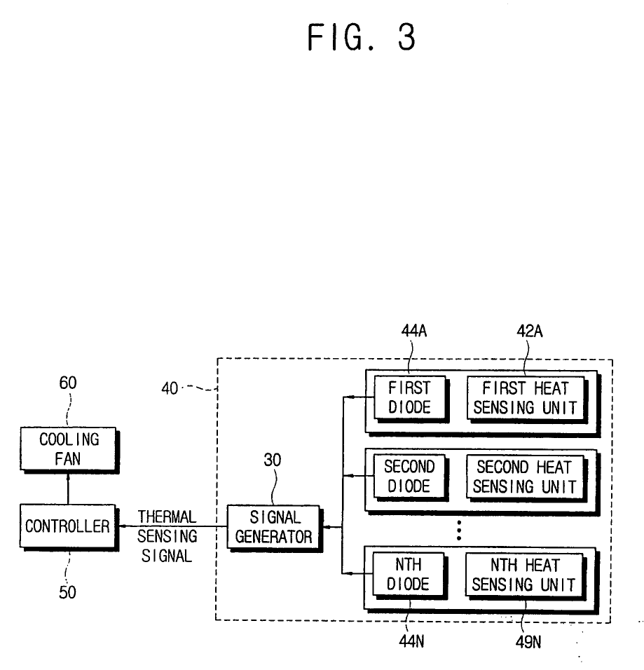

FIG. 3 is a block diagram of an example computer system incorporating a thermal sensing apparatus according to an embodiment of the present invention. As shown in FIG. 3, the computer system according to the present invention includes a thermal sensing apparatus 40 for sensing a temperature of a plurality of points or positions in the computer system, and outputting a thermal sensing signal according to a sensing result of the plurality of points; a cooling fan 60 for cooling a sensing subject of the plurality of points, and a controller 50 for controlling a cooling drive of the cooling fan 60 based on the thermal sensing signal output from the thermal sensing apparatus 40.

The thermal sensing apparatus 40 includes a plurality of heat sensing units 42A-42N (i.e., a first heat sensing unit RTH1, and a second heat sensing unit RTH2, and a nth heat sensing unit RTHn) provided in a plurality of positions for sensing heat generated from different circuit parts within the computer system; a plurality of switching units, i.e., diodes 44A-44N connected to the plurality of heat sensing units 42A-42N for interrupting an interference of the plurality of heat sensing units 42A-42N; and a signal generator 30 which compares a predetermined standard voltage and an input signal voltage, which is changed when at least one of the plurality of diodes 44A-44N is connected, based on the sensing result from the plurality of heat sensing units 42A-42N, and then generates a thermal sensing signal according to the comparison result.

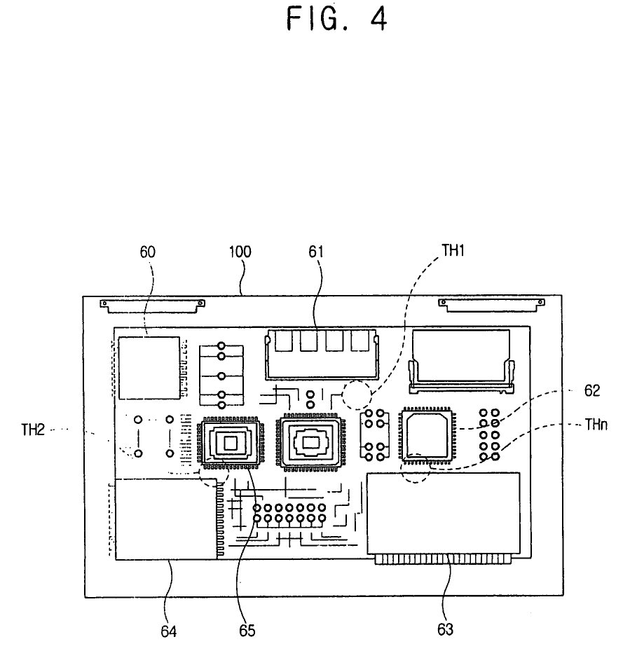

The plurality of points or positions where the plurality of heat sensing units 42A-42N are arranged will be described with reference to FIG. 4 herein below.

FIG. 4 illustrates an example of how various circuit parts are disposed on a main printed circuit board (PCB) 100 provided in a computer system according to an embodiment of the present invention. As shown in FIG. 4, the circuit parts of various functions disposed on the PCB 100 includes, for example, a cooling fan 60 for generating cooling air, a memory 61, a south bridge 62, a hard disk drive (HDD) 63, an inverter module 64, a central processing unit (CPU) 65 and the like.

The plurality of heat sensing units 42A-42N, as shown in FIG. 3, can be arranged to sense a temperature of the circuit parts, including, for example, the memory 61, the south bridge 62, the HDD 63, the inverter module 64, the CPU 65 and the like, as shown in FIG. 4. For example, the first heat sensing unit 42A can be affixed to a TH1 point, as shown in FIG. 4, for sensing the temperature of the memory 61. Similarly, the second heat sensing unit 42B can be provided in a TH2 point for sensing the temperature of the inverter module 64 and the CPU 65. Likewise, the nth heat sensing unit 42N can be provided in a THn point for sensing the temperature of the south bridge 62 and the HDD 63. Alternatively, each heat sensing unit may be connected directly to each circuit part, rather than multiple parts, to sense a temperature variation of the circuit part and report the sensing result to the controller 50, via the signal generator 30, as shown in FIG. 3.

The controller 50 receives the thermal sensing signal output from the signal generator 46 of the thermal sensing apparatus 40, as shown in FIG. 3, controls the operation of the cooling fan 60, i.e., to turn the cooling fan 60 on/off and then controls a fan rotating speed of the cooling fan 60, based on the thermal sensing signal. As a result, the cooling fan 60 generates the cooling air according to the controller 50, and then lowers the temperature of the various circuit parts 61, 62, 63, 64, and 65 provided in the computer system, as shown, for example, in FIG. 4.

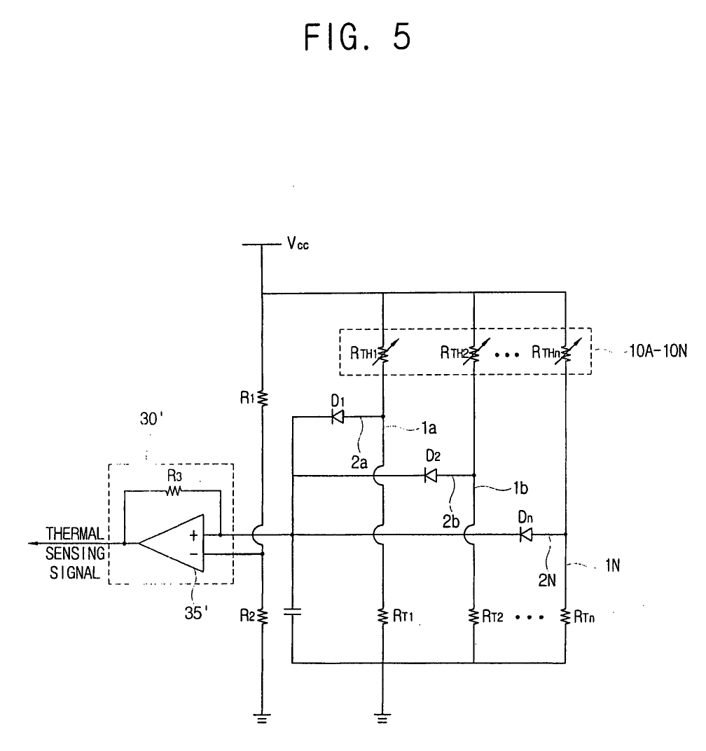

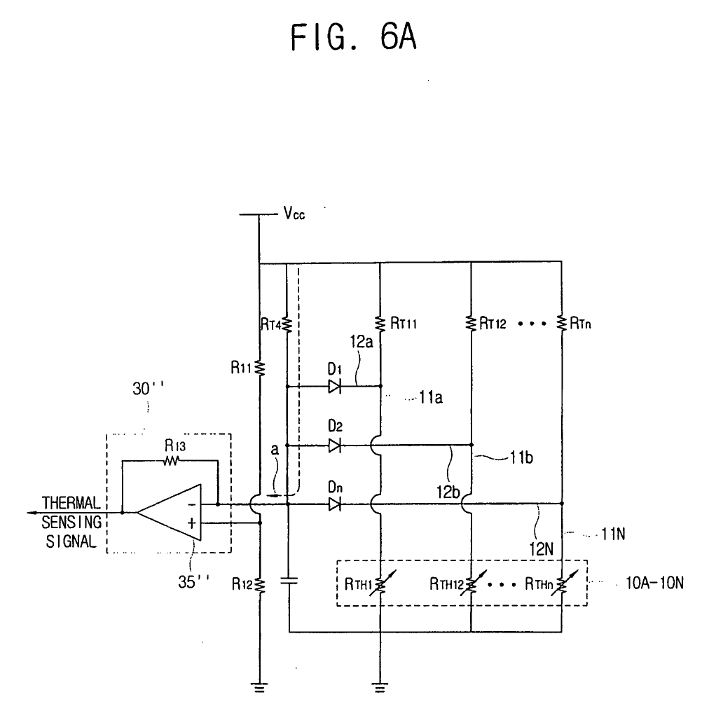

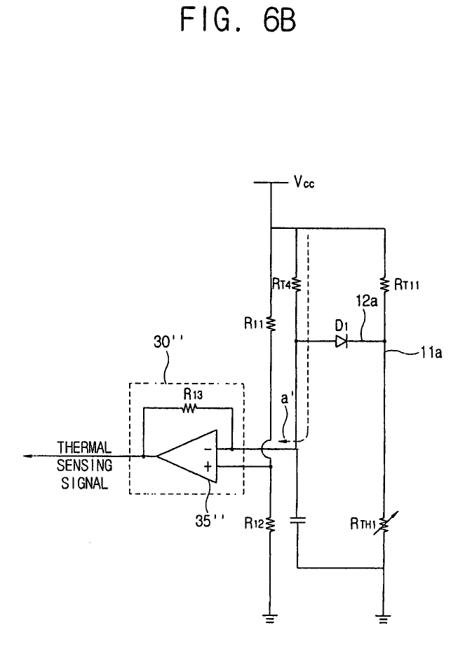

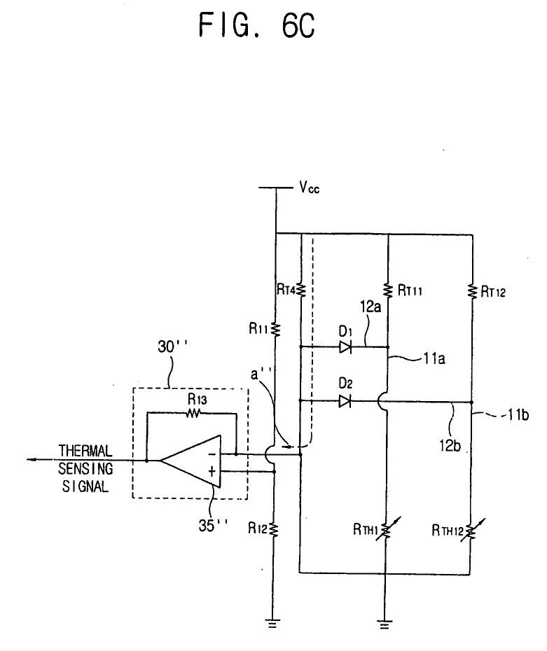

Various embodiments of the thermal sensing apparatus 40 for supplying the thermal sensing signal, which is based on controlling the cooling fan 60, to the controller 50 will be described with reference to FIGS. 5 and 6A herein below. The example embodiments of the FIGS. 5 and 6A will be described based on the FIGS. 3 and 4.

FIG. 5 is a circuit diagram of an example thermal sensing apparatus 40 for sensing a temperature of a plurality of points according to a first embodiment of the present invention. As shown in FIG. 5, the thermal sensing apparatus 40 comprises a plurality of thermistors 10A-10N, which are respectively provided in the plurality of points TH1, TH2, and THn for sensing heat of the plurality of circuit parts 61, 62, 63, 64, 65; a plurality of diodes D1, D2, and Dn each of which is provided in a rear end of each thermistor for intercepting an interference of the plurality of thermistors 10A-10N; and a signal generator 30′ which compares a predetermined standard voltage, which is provided from a power supply source Vcc, and an input signal voltage, which is changed according as at least one of the plurality of diodes D1, D2, and Dn is connected by change of an electric resistance value of the plurality of thermistors 10A-10N, and generates a thermal sensing signal according to a comparison result.

The plurality of thermistors 10A-10N serve as the heat sensing units 42A-42N, as shown in FIG. 3, and include thermistors RTH1, RTH2, and RTHn arranged in parallel with each other, and each of which is respectively provided in a designated point TH1, TH2 or THn for sensing heat generated from one or more circuit parts used as sensing subjects. Herein, each of the thermistors RTH1, RTH2, and RTHn corresponds to the first heat sensing unit RTH1, the second heat sensing unit RTH2, and the nth heat sensing unit RTHn as shown in FIG. 3, which are respectively provided in the TH1 point, the TH2 point, and the THn point as shown in FIG. 4. Preferably, each thermistor RTH1, RTH2, and RTHn may be a semiconductor circuit element of which the electric resistance value decreases as a peripheral temperature (i.e., temperature of each circuit part provided with each thermistor) rises.

As shown in FIG. 5, in the rear end of each of the thermistors RTH1, RTH2, and RTHn are provided ground lines 1a, 1b, and 1n, and connection lines 2a, 2b, and 2n.

The ground lines 1a, 1b, and 1n include predetermined ground resistors RT1, RT2, and RTn connected to the rear end of each of the thermistors RTH1, RTH2, and RTHn. The ground lines 1a, 1b, and 1n are used as a power pathway that the power supplied from a predetermined power supply source Vcc passes through each of the thermistors RTH1, RTH2, and RTHn and each of the ground resistors RT1, RT2, and RTn to be grounded.

The connection lines 2a, 2b, and 2n are branched between the rear end of each of the thermistors RTH1, RTH2, and RTHn, and each of the ground resistors RT1, RT2, and RTn as a signal line and then connected to the signal generator 30′. Herein, each of the connection lines 2a, 2b and 2n includes each of the diodes D1, D2, and Dn provided in parallel with each of the ground resistors RT1, RT2, and RTn, and an anode terminal of each diode D1, D2, and Dn is connected to a branch point, and a cathode terminal of each diode D1, D2, and Dn is connected to the signal generator 30′. Therefore, when each diode D1, D2, and Dn is connected, the connection lines 2a, 2b, and 2n are used as the power pathway that allows the connection signal of the output power passing through each of the thermistors RTH1, RTH2, and RTHn among the power supplied from the power supply source Vcc to be supplied the signal generator 30′ through each diode D1, D2, and Dn.

The signal generator 30′, as shown in FIG. 5, can be implemented by a comparator 35′ (or an amplifier) having a non-inverting terminal (+) arranged to receive the connection signal from each of the thermistors RTH1, RTH2 and RTHn, via the diodes D1, D2 and Dn, and an inverting terminal (−) arranged to receive a standard voltage provided from the power supply source Vcc; and a resistor R3 connected in parallel with the comparator 35′.

Each connection signal which is supplied through each of the diodes D1, D2, and Dn provided in the connection lines 2a, 2b, and 2n are summed, and the summed connection signal is inputted to a non-inverting terminal (+) of the comparator 35′ as the input signal. The standard voltage is input to an inverting terminal (−) of the comparator 35′. At this time, the comparator 35′ compares the voltage of the input signal and the standard voltage, and then outputs a predetermined thermal sensing signal according to the comparison result to the controller 50.

Therefore, the controller 50 may control the operation of the cooling fan 60 and the fan rotating speed for cooling the circuit parts provided with each of the thermistors RTH1, RTH2, and RTHn, according to the thermal sensing supplied from the signal generator 30′.

Alternatively, the signal generator 30′ may be provided with a comparator 35′, without the resistance R3, which generates a low signal in case where the standard voltage is larger than the voltage of the input signal, and generates a high signal in case where the voltage of the input signal is larger than the standard voltage as simply comparing the voltage of the input signal with the standard voltage. In this case, the controller 50 may control only the operation of the cooling fan 60 for cooling the circuit parts provided with each of the thermistors RTH1, RTH2, and RTHn, according to the thermal sensing signal (i.e., the high/low signal) supplied from the signal generator 30′.

However, a ground resistor R2 should be arranged between the power supply source Vcc and ground for supplying the standard voltage to each of the thermistors RTH1, RTH2, and RTHn, each of the ground resistors RT1, RT2, and RTHn, and the comparator 35′, in consideration of a limitation imposed from the a raising temperature of each circuit part provided with each of the thermistors RTH1, RTH2, and RTHn, a variation of the electric resistance value of each of the thermistors RTH1, RTH2, and RTHn, and generation time of the thermal sensing signal (i.e., the cooling fan On/Off control signal).

The process that the thermal sensing apparatus according to the first embodiment of the present invention as shown in FIG. 5 outputs the thermal sensing signal, will be described as follows. Herein, the signal generator 30′ is consisted of only the comparator 35′ and outputs only the high/low signal.

In case where the temperature of the circuit part provided with each of the thermistors RTH1, RTH2, and RTHn is normal, each of the diodes D1, D2, and Dn is not connected, and the power supplied from the power supply terminal Vcc flows through the ground lines 1a, 1b, and 1n passing through each of the thermistors RTH1, RTH2, and RTHn and each of the ground resistors RT1, RT2, and RTn. As a result, the signal generator 30′ outputs a low signal. At this time, if the temperature of the memory 61 at the TH1 point provided with the thermistor RTH1 raises, the electric resistance value of the thermistor RTH1 reduces. Therefore, the voltage applied to the anode terminal of the diode D1 becomes large, and then the moment the voltage of the anode terminal is larger than the voltage of the cathode terminal, the diode D1 is activated so that the connection signal output from the thermistor RTH1 is supplied to the signal generator 30′ along the connection line 2a. Therefore, the higher the temperature of the memory 61 is, the larger the voltage of the connection signal supplied to the signal generator 30′ is. As a result, the comparator 35′ outputs a high signal to the controller 50, in case the connection signal which is supplied to the non-inverting terminal (+) of the comparator 35′ through the diode D1, (i.e., the input signal) is larger than the standard voltage provided from the power supply source Vcc.

Turning now to FIG. 6A, a circuit diagram of an example thermal sensing apparatus for sensing a temperature of a plurality of points or positions in a computer system according to a second embodiment of the present invention is illustrated.

As shown in FIG. 6A, the thermal sensing apparatus 40 comprises a plurality of thermistors 10A-10N, which are respectively provided in a plurality of points TH1, TH2, and THn for sensing heat of a plurality of circuit parts 61, 62, 63, 64, and 65; a plurality of diodes D1, D2, and Dn each of which is provided in a front end of each thermistor for intercepting the interference of the plurality of thermistors 10A-10N; and a signal generator 30″ which compares a predetermined standard voltage provided from a power supply source Vcc and an input signal voltage, which is changed according as at least one of the plurality of diodes D1, D2, and Dn is connected by change of an electric resistance value of the plurality of thermistors 10A-10N , and then generates a predetermined sensing signal according to a result of such a comparison.

The plurality of thermistors 10A-10N serve as the heat sensing units 42A-42N, as shown in FIG. 3, and include thermistors RTH1, RTH2, and RTHn arranged in parallel with each other, and each of which is respectively provided in a designated point TH1, TH2 or THn for sensing heat generated from one or more circuit parts used as sensing objects. Herein, each of the thermistors RTH1, RTH2, and RTHn corresponds to the first heat sensing unit RTH1, the second heat sensing unit RTH2, and the nth heat sensing unit RTHn as shown in FIG. 3, which are respectively provided in a TH1 point, a TH2 point, and a THn point as shown in FIG. 4. Preferably, each of the thermistors RTH1, RTH2, and RTHn may be a semiconductor circuit element (i.e., the resistance) of which the electric resistance value decreases as a peripheral temperature (i.e., temperature of each circuit part provided with the thermistor) rises.

As shown in FIG. 6A, in the front end of each of the thermistors RTH1, RTH2, and RTHn are provided first lines 11a, 11b, and 11n and second lines 12a, 12b, and 12n.

The first lines 11a, 11b, 11n include a predetermined each first resistance RT11, RT12, and RTn connected to the front end of each of the thermistors RTH1, RTH2, and RTHn, and are used as a power pathway that the power supplied from a predetermined power supply source Vcc passes through each first resistance RT11, RT12, and RTn and each of the thermistors RTH1, RTH2, and RTHn to be grounded.

The second lines 12a, 12b, and 12n include each of the diodes D1, D2, and Dn provided in parallel with each first resistance RT11, RT12, and RTn, and having an anode terminal which receives each connection signal from a predetermined power supply source Vcc, and a cathode terminal connecting to a union point in which signal lines are unified between the front end of each of the thermistors RTH1, RTH2, and RTHn and each first resistance RT11, RT12, and RTn. Therefore, when each diode D1, D2, and Dn is connected, the second lines 12a, 12b,and 12n are used as a power pathway that the connection signal among the power, which is supplied from the power supply source Vcc and passes through a resistance RT4, passes through each of the diodes D1, D2, and Dn to be supplied to each of the thermistors RTH1, RTH2, and RTHn.

The power, which is dropped after flowing the diodes D1, D2, and Dn through the second lines 12a, 12b, and 12n, among the power from the power supply source Vcc, is input through an inverting terminal (−) as an input signal. The standard voltage is input to a non-inverting terminal (+). At this time, the signal generator 30″ compares the voltage of the input signal and the standard voltage, and then outputs a thermal sensing signal according to the comparison result to the controller 50.

Therefore, the controller 50 may control the operation of the cooling fan 60 and the fan rotating speed for cooling the circuit parts provided with the thermistors RTH1, RTH2, and RTHn, according to the thermal sensing supplied from the signal generator 30″.

Similarly to FIG. 5, the signal generator 30″ as shown in FIG. 6A may be provided with a comparator 35″, without the resistance R13, which generates a low signal in case where the voltage of the input signal is larger than the standard voltage, and generates a high signal in case where the standard voltage is larger than the voltage of the input signal. In this case, the controller 50 may control only the operation of the cooling fan 60 for cooling the circuit parts provided with each of the thermistors RTH1, RTH2, and RTHn, according to the thermal sensing signal (i.e., the high/low signal) supplied from the signal generator 30″.

In addition, a ground resistor R12 should also be arranged between a power supply source Vcc and ground for supplying the standard voltage to each of the thermistors RTH1, RTH2, and RTHn, each of the ground resistors RT1, RT2, and RTHn, and the comparator 35″, in consideration of the rising temperature of one or more circuit parts provided with a corresponding one of the thermistors RTH1, RTH2, and RTHn, a variation of the electric resistance value of each of the thermistors RTH1, RTH2, and RTHn, and generation time of the thermal sensing signal (i.e., the cooling fan On/Off control signal).

The process that the thermal sensing apparatus according to the second embodiment of the present invention as shown in FIG. 6A outputs the thermal sensing signal, will be described with reference to FIGS. 6B, and 6C as follows. Herein, the signal generator 30″ is consisted of only the comparator 35″ and outputs only the high/low signal.

In case where the temperature of the one or more circuit parts provided with each of the thermistors RTH1, RTH2, and RTHn is normal, each the diodes D1, D2, and Dn is not connected, and the power supplied from the power supply source Vcc flows through the first lines 11a, 11b, 11n passing through each of the thermistors RTH11, RTH12, and RTHn and each first resistance RT11, RT12, and RTn. Therefore, the signal generator 30″ receives the power which is voltage-dropped through the resistance RT4 and is supplied from the power supply source Vcc, as the input signal (refer to “a” flow). As a result, the signal generator 30″ outputs the low signal to the controller 50 because the input signal is larger than the standard voltage. At this time, if the temperature of the memory 61 at the TH1 point provided with the thermistor RTH1 rises, the electric resistance value of the thermistor RTH1 reduces. Therefore, the voltage applied to the cathode terminal of the diode Dl is smaller, and then the moment the voltage of the cathode terminal is smaller than the voltage of the anode terminal, the diode D1 is connected.

Therefore, an equivalent circuit such as shown in FIG. 6B is formed, and power a′ dropped as much as the connection signal, which is output through the diode D1 of the second line 12a to the thermistor RTH1, among the power supplied from the power supply source Vcc (“a” flow) is supplied to the signal generator 30″ as an input signal. Therefore, the higher the temperature of the memory 61 is, the smaller the voltage of the input signal supplied to the signal generator 30″ is. In case where the standard voltage is larger than the input signal a′, the comparator 35″ outputs the high signal to the controller 50.

Here, if a temperature of the inverter module 64 and/or the CPU 65 at the TH2 point provided with the thermistor RTH2, as shown in FIG. 4, also rises, the electric resistance value of the thermistor RTH2 reduces. Accordingly, the voltage of the cathode terminal of the diode D2 becomes small, and then the moment the voltage applied to the cathode terminal is smaller than the voltage of the anode terminal, the diode D2 is connected.

That is, if both the diode D1 and the diode D2 are connected, an equivalent circuit such as shown in FIG. 6C is formed. Therefore, power a″ dropped as much as the connection signals, which are output through the diodes D1, D2 of the second line 12a, 12b to the thermistors RTH1, RTH2 among the power supplied from the power supply source Vcc (“a” flow) is supplied to the signal generator 30″ as an input signal. Therefore, the higher the temperature of the memory 61, the inverter module 64 and the CPU 65 is, the smaller the input signal a″ supplied to the signal generator 30″ is. When the standard voltage is larger than the input signal a″, the comparator 35″ of the signal generator 30″ outputs the high signal to the controller 50.

Herein, in case where the signal generators 30′, 30″ have the resistances R3, R13 as well as the comparators 35′, 35″ and perform a differential amplifying function, the signal generators 30′, 30″ output the different thermal sensing signals according to a value of difference between the standard voltage and the input signal. As a result, the controller 50 controls the fan rotating speed of the cooling fan 60, corresponding to the different thermal sensing signals.

With this configuration, because of using the simple diode module, the thermal sensing apparatus according to various embodiments of the present invention advantageously reduce the cost of production caused by expensive thermal sensor ICs and the mounting space required to sense the temperature of a plurality of points or positions within a computer system. Further, the thermal sensing apparatus according to the present invention may sense the temperature of the plurality of points through performing of a simple analog circuit using a simple diode module, so that it may solve the problem of complication of the circuit, communication error, and deterioration of reliability.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the thermal sensing apparatus can be implemented for use in all electronic devices, including a computer system and other consumer electronic devices, which require a cooling fan to reduce the heat generated from different circuit parts. In addition, the thermal sensing apparatus can be configured differently from that shown in FIG. 3, FIG. 5, and FIGS. 6A-6C, as long as the diode module is utilized in the manner described. Similarly, the printed circuit board can have circuit parts different from those shown in FIG. 4. Likewise, one or more cooling fans can be implemented and can still be controlled in the same manner as described in different embodiments of the present invention. Further, aspects of the thermal sensing apparatus shown in FIG. 3, FIG. 5 and FIGS. 6A-6C can be incorporated into a chipset having firmware, or alternatively, a general or special purposed computer programmed to sense a temperature variation from different circuit parts within an electronic system, whether automatically or semi-automatically, when the electronic system is turned on. Accordingly, it is intended, therefore, that the present invention not be limited to the various example embodiments disclosed, but that the present invention includes all embodiments falling within the scope of the appended claims.

What is claimed is:

1. A thermal sensing circuit comprising:
a plurality of heat sensing units arranged to sense a temperature of a plurality of circuit parts;
a plurality of switching units arranged to activate the plurality of heat sensing units; and
a signal generator arranged to compare a predetermined voltage and an input signal, which is changed when at least one of the plurality of switching units turns on, based on a sensing result from the plurality of heat sensing units, and generate a thermal sensing signal based on a comparison result.

2. The thermal sensing circuit according to claim 1, wherein each of the plurality of heat sensing units comprises a thermistor arranged as a semiconductor circuit element of which an electric resistance value reduces when a temperature of the corresponding one or more circuit parts rises, and each of the plurality of switching units comprises a diode connected according to a variation of the electric resistance value of the plurality of thermistors.

3. The thermal sensing circuit according to claim 1, further comprising:
ground lines passing through the plurality of thermistors and predetermined ground resistors connected to rear ends of the plurality of thermistors; and
connection lines which are branched between the rear ends of the plurality of thermistors and the ground resistors to allow connection signals output from the plurality of thermistors to pass through the plurality of diodes and to be supplied to the signal generator,
wherein the plurality of diodes are disposed in parallel with the ground resistors.

4. The thermal sensing circuit according to claim 3, wherein each of the plurality of diodes is provided in the connection line and has an anode terminal connected to the rear end of each of the plurality of thermistors, and a cathode terminal connected to the signal generator.

5. The thermal sensing circuit according to claim 4, wherein the signal generator corresponds to a comparator having a non-inverting terminal to which the connection signals supplied from the plurality of diodes provided in the connection lines are input as the input signal, and an inverting terminal to which the predetermined voltage is input, and compares the voltage of the input signal with the predetermined voltage and generates the thermal sensing signal based on the comparison result.

6. The thermal sensing circuit according to claim 5, wherein the comparator which generates a low signal when the predetermined voltage is larger than the voltage of the input signal, and generates a high signal when the voltage of the input signal is larger than the predetermined voltage, based on the comparison result.

7. The thermal sensing circuit according to claim 1, further comprising:
first lines passing through first resistors connected to front ends of the plurality of thermistors and the plurality of thermistors to be grounded; and
second lines which pass through the plurality of diodes and are connected to the plurality of thermistors through union points between the first resistors and the front ends of the plurality of thermistors,
wherein the plurality of diodes are disposed in parallel with the first resistors, and are provided in the second lines and have anode terminals receiving the connection signals from a power supply source, and cathode terminals connected to the union points and supplying the connection signals to the plurality of thermistors.

8. The thermal sensing apparatus according to claim 7, wherein the signal generator corresponds to a comparator having an inverting terminal to which a power provided from the power supply source and dropped according to the connection signals input to the anode terminal of the diode is input as the input signal, and a non-inverting terminal to which the predetermined voltage is input, and compares the voltage of the input signal with the predetermined voltage and generates the thermal sensing signal according to the comparison result.

9. The thermal sensing apparatus according to claim 1, wherein the signal generator comprises a comparator which generates a low signal when the voltage of the input signal is larger than the predetermined voltage, and generates a high signal when the predetermined voltage is larger than the voltage of the input signal, based on the comparison result.

10. A computer system, comprising:
a thermal sensing circuit arranged to sense a temperature of a plurality of circuit parts located within the system and to generate a thermal sensing signal;
a cooling fan operable to cool one or more circuit parts; and
a controller for controlling the operation of the cooling fan, based on the thermal sensing signal generated from the thermal sensing circuit,
wherein the thermal sensing circuit comprises:
a plurality of heat sensing units each of which is arranged at a position where one or more circuit parts are located;
a plurality of switching units connected to the plurality of heat sensing units; and
a signal generator which compares a predetermined voltage and an input signal, which is changed when at least one of the plurality of switching units turns on, based on a sensing result from the plurality of heat sensing units, and which generates the thermal sensing signal to control the operation of the cooling fan based on a comparison result.

11. The computer system according to claim 10, wherein each of the plurality of heat sensing units is a thermistor arranged to reduce an electrical resistance value when a temperature of the corresponding one or more circuit parts rises, and wherein each of the plurality of switching units is a diode connected according to a variation of the electric resistance value of the corresponding thermistor.

12. The computer system according to claim 11, wherein the thermal sensing circuit comprises:
ground lines passing through the plurality of thermistors and predetermined ground resistors connected to rear ends of the plurality of thermistors; and
connection lines which are branched between rear ends of the plurality of thermistors and the ground resistors to allow connection signals output from the plurality of thermistors to pass through the plurality of diodes and to be supplied to the signal generator,
wherein the plurality of diodes are disposed in parallel with the ground resistors.

13. The computer system according to claim 12, wherein each of the plurality of diodes is provided in the connection line and has an anode terminal connected to the rear end of each of the plurality of thermistors, and a cathode terminal connected to the signal generator.

14. The computer system according to claim 13, wherein the signal generator is a comparator having a non-inverting terminal to which the connection signals supplied from the plurality of diodes provided in the connection lines are input as an input signal, and an inverting terminal to which the predetermined standard voltage is input, to compare the voltage of the input signal with the predetermined voltage and generate the thermal sensing signal based on the comparison result.

15. The computer system according to claim 14, wherein the comparator generates a low signal when the predetermined voltage is larger than the voltage of the input signal, and generates a high signal when the voltage of the input signal is larger than the predetermined voltage, based on the comparison result.

16. The computer system according to claim 11, wherein the thermal sensing circuit comprises:
first lines passing through first resistors connected to front ends of the plurality of thermistors and the plurality of thermistors to be grounded; and
second lines which pass through the plurality of diodes and are connected to the plurality of thermistors through union points between the first resistors and the front ends of the plurality of thermistors,
wherein the plurality of diodes are disposed in parallel with the first resistors.

17. The computer system according to claim 16, wherein the plurality of diodes are provided in the second lines and have anode terminals receiving the connection signals from a power supply source, and cathode terminals connected to the union points and supplying the connection signals to the plurality of thermistors.

18. The computer system according to claim 17, wherein the signal generator is a comparator having an inverting terminal to which a power provided from the power supply source and dropped according to the connection signals input to the anode terminal of the diode is input as the input signal, and a non-inverting terminal to which the predetermined voltage is input, to compare the voltage of the input signal with the predetermined voltage and generate the thermal sensing signal based on the comparison result.

19. The computer system according to claim 18, wherein the comparator generates a low signal when the voltage of the input signal is larger than the predetermined voltage, and generates a high signal when the predetermined voltage is larger than the voltage of the input signal, based on the comparison result.
